(19) United States
(12) Patent Application Publication
(10) Pub. No.: US 2010/0200644 A1
(43) Pub. Date: Aug. 12, 2010

(54) SOLDERING APPARATUS

(75) Inventor: Michael Tombs, Essex (GB)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Pillarhouse International Limited, Chelmsford, Essex (GB)

(21) Appl. No.: 12/302,781

(22) PCT Filed: May 30, 2007
(86) PCT No.: PCT/GB2007/001988

§ 371 Date: Feb. 23, 2009

(30) Foreign Application Priority Data
May 30, 2006 (GB) 0610679.3

(51) Int. Cl. B23K 31/02; B23K 3/06; B23K 1/20

(52) U.S. Cl. 228/219; 228/33

(57) ABSTRACT

A selective soldering apparatus comprises a bath 3 for molten solder 5, a solder nozzle 19 and a pump 9 for pumping molten solder 5 through the nozzle 19. The nozzle has a nozzle body 21 with an inner bore 22 through which solder is pumped to overflow a nozzle outlet 33. A jacket 23 provided around the nozzle body 21 to form an enclosed space 26 open at its upper end 28 to solder which has overflowed from the nozzle outlet 33 and the cover lower end being adjacent the surface 11 of molten solder in the bath, wherein a spiral pathway 25 is provided in the enclosed space 26 so that the overflowed solder runs down the pathway into the solder bath 3. A port 39 is provided at the lower end of the jacket for gas to flow into or out of the spiral pathway so that the pathway can be purged of air when solder is not flowing through the pathway.

### CROSS-REFERENCE TO RELATED APPLICATIONS

This application is a continuation of PCT/GB2007/001988 filed on May 30, 2007, which claims priority to GB 0610679.3 filed on May 30, 2006, the disclosures of each are incorporated herein by reference.

### FIELD OF THE INVENTION

The present invention relates to a soldering apparatus and in particular to a nozzle for a selective soldering apparatus.

### BACKGROUND OF THE INVENTION

It is well known to provide a selective soldering apparatus in which solder is pumped from a bath of molten solder to a nozzle outlet and component leads on a printed circuit board are dipped into the solder to solder them to the board printed circuit tracks. The solder may be pumped to over flow the nozzle outlet, returning to the solder bath. The pump speed may be varied to adjust the height of the solder at the nozzle outlet. It may be increased intermittently to clean or clear the solder surface at the nozzle outlet. It may also be reduced or stopped to lower the solder surface, for example to pull the solder away from the leads when withdrawing the leads from the solder.

Manufacturers require that soldering is performed in a nitrogen atmosphere, with very low oxygen content. This improves the quality of the solder joint and helps prevent the formation of dross—oxidised solder. Dross formation is a substantial problem as it results in large quantities of waste solder which must be recovered and can result in bad solder joints if it contaminates the solder flow. The formation of dross is exacerbated by pumping of the solder and its flow through the solder nozzle and back to the bath. Splashing of the solder as it enters the bath leads to increased dross formation.

With large solder baths, the formation of dross can be tolerated for some time before it is necessary to clean the bath surface and/or replace the solder in the bath.

However, we provide a small bath which is particularly suitable for selective soldering operations in which the board is stationary and the bath is moved vertically and horizontally to solder the components to the board. With a small size bath it becomes especially important to minimise dross formation otherwise the bath must be cleaned at frequent intervals, resulting in significant down time of the soldering apparatus and the associated production line.

### SUMMARY OF THE INVENTION

Thus in one aspect of our invention we provide a solder nozzle having a nozzle body with an inner bore through which solder is pumped to overflow a nozzle outlet. A jacket is provided around the nozzle body to form an enclosed space open at its upper end to receive overflowed solder and communicating at its lower end with the molten solder in the bath. A spiral pathway is provided in the enclosed space so that solder runs down the pathway into the solder bath. The lower end of the spiral may extend to or into the surface of the solder in the bath to provide a continuous path into the solder in the bath. Thus the overflowed solder can be returned to the solder bath without splashing at the surface of the solder in the bath.

Nitrogen gas is fed to the region of the nozzle outlet via a shroud. The shroud surrounds the upper end of the jacket and terminates at the level of the nozzle outlet or below so as not to inhibit access of the nozzle to component leads. The nitrogen inhibits dross formation and also reduces the surface tension of the solder to improve the solder flow. The nitrogen may reduce the solder temperature. Thus in another aspect of our invention we pre-heat the nitrogen by passing the nitrogen along a sinuous tube which is in thermal contact with the solder bath, and in particular may be mounted on the outer surface of the bath wall.

We have found that there is a particular problem with feeding nitrogen into the spiral pathway between the nozzle body and the jacket. Insufficient nitrogen in this region can result in a skin forming on the solder as it runs down the spiral and this may eventually lead to blockage of the spiral pathway. Thus another aspect of our invention provides a port at the lower end of the jacket for nitrogen to flow into or out of the spiral pathway, and hence the full length of the pathway can be purged with nitrogen. Solder may exit the port, and so we prefer to provide a cup around the jacket at the port to collect the solder. The cup may have apertures at its lower end to feed the solder back to the solder bath.

When starting the apparatus, with the solder at the required soldering temperature, the nitrogen gas flow purges the space between the nozzle body and the jacket. Solder is then pumped through the nozzle body to overflow the nozzle outlet and run down into the spiral path way. The nozzle outlet is formed by a tip which forms an overhang on the nozzle body. This, together with the nitrogen atmosphere, breaks the skin tension of the solder as it drops down to the spiral pathway to provide a rapid and smooth solder run-off.

The solder runs down the spiral pathway and flows off the bottom of the spiral into the solder bath and/or out of the port and into the bath via the cup.

Another aspect of our invention provides a selective soldering apparatus comprising a solder pump having a radial blade impeller in a substantially circular cross-section impeller pump chamber, wherein an outlet is formed on a diameter of the pump chamber. The outlet feeds away from the pump chamber along a radial line, rather than at angle to the radius. We believe that this might give particularly good control over the flow of solder and help reduce formation of solder dust.

The invention will be further described by way of example with reference to the accompanying drawings in which:

### BRIEF DESCRIPTION OF THE DRAWINGS

FIG. 1 is a cross-section through a soldering apparatus of the invention;

FIG. 2 is an external view of a solder bath of the apparatus of FIG. 1, and

FIG. 3 is a horizontal cross section though a pump of the embodiment of FIG. 1 along line III-III.

### DETAILED DESCRIPTION

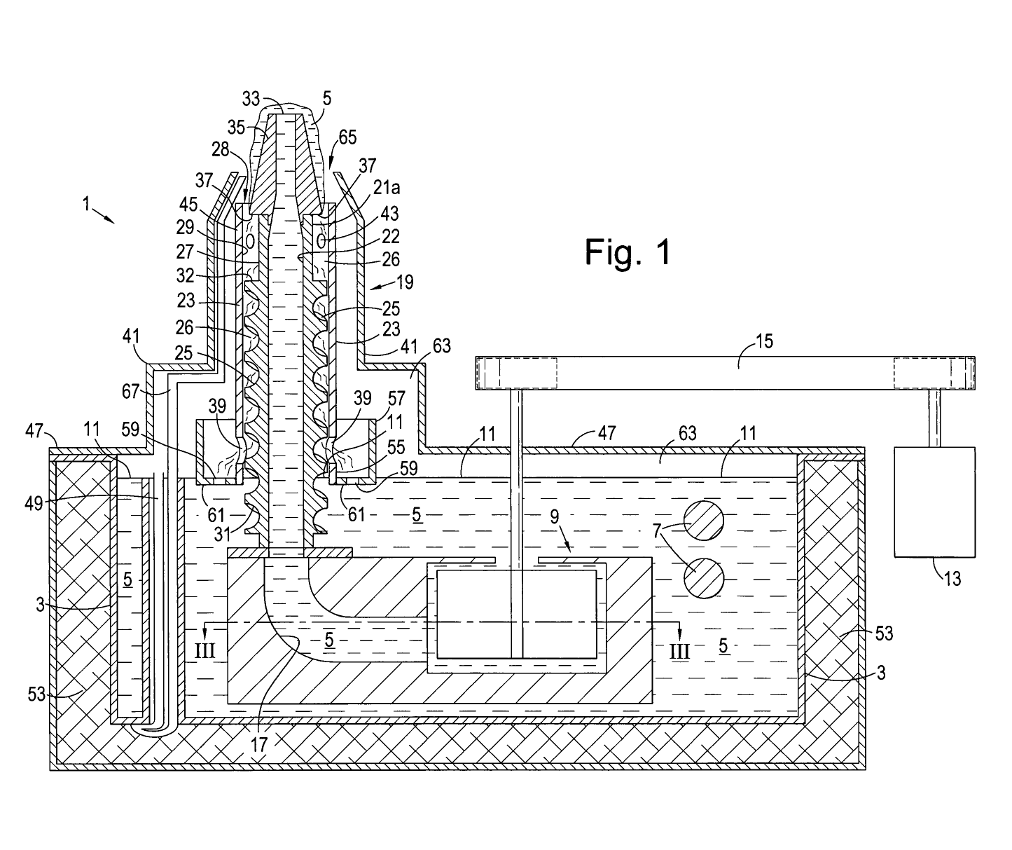

Referring to FIG. 1, a selective soldering apparatus 1 includes a bath 3 for containing molten solder 5. The solder 5 is heated by an electric heater 7. An impeller type pump 9 is housed in the solder bath 3 below the upper surface 11 of the solder 5 and is driven by an electric motor 13 via a belt 15. The pump 9 pumps molten solder through a conduit 17 to a nozzle 19.

Nozzle 19 comprises a nozzle body 21 having an inner bore 22 fluidly connected to the conduit 17. The nozzle body 21 is surrounded by a jacket 23 which extends down to the solder surface 11. A spiral pathway 25 is formed on the outer surface 27 of the nozzle body 21 in the space 26 between the nozzle body 21 and the jacket 23. The space is open at its upper end 28. It will be appreciated that the pathway 25 may be formed on the inner surface 29 of the jacket 23 or provided as a separate unit. The lower end 31 of the spiral path 25 extends down to the solder surface 11. The upper end 32 of the spiral path stops below the nozzle outlet 33. Nozzle outlet 33 is formed by a removable iron tip 35 which is screwed into the upper end of the nozzle body portion 21a. Iron tip 35 forms an overhang 37 on the outer surface 27 of the nozzle body 21 and the upper end 26 of the spiral pathway 25 is located below the overhang 37. Adjacent the lower end of the spiral pathway 25 several ports 39, in this embodiment eight, are formed in the lower end 55 of the jacket 23. Apertures 43 are also provided in the upper end 45 of the jacket 23.

A cup 57 is mounted around the lower end 55 of the jacket 23. Cup 57 has slots 59 in its bottom wall 61. Cup 57 is positioned so that its bottom wall 61 just breaks the surface 11 of the molten solder 5.

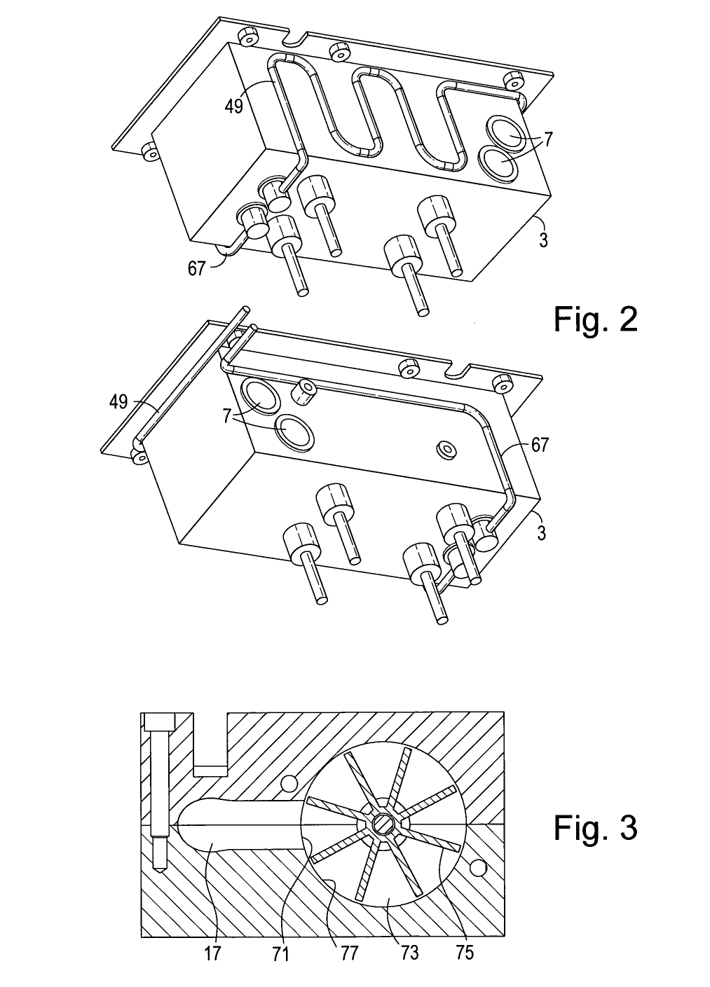

A shroud 41 is positioned around the upper end 45 of the cover 23 and below the nozzle outlet 33. Shroud 41 connects with a bath cover 47 to form an enclosure above the molten solder 5, so the space 63 above the solder 5 can be purged with nitrogen gas. The nitrogen is fed below cover 47 via metal tube 49 which is mounted on the outer surface 51 of the bath 3 (se FIG. 2). Bath 3 is surrounded by insulation 53. Thus the nitrogen gas is preheated by its passage through the tube 49.

In use, the solder 5 is heated to its required soldering temperature. Pump 9 is run at low speed so that solder does not overflow the nozzle outlet 33. Nitrogen gas is flowed into the space 63 and out through the upper end 65 of the shroud which is below the level of nozzle outlet 33. The nitrogen gas purges the space 63 of air and in particular oxygen. A dedicated nitrogen tube 67 may be provided in the shroud 41 to direct pre-heated nitrogen gas to a point just above outlet 33, so that pre-heated gas is directed to a joint which is about to be soldered. The region between the nozzle body 21 and the cover 23 housing the spiral pathway 25 is also purged by gas entering or leaving the ports 39. After purging, nitrogen gas flow is continued and the pump speed increased to cause the solder to overflow the nozzle outlet 33. The solder runs down the outside of the nozzle tip 35 and drops off the overhang 37 and onto the spiral pathway 25. The solder runs quickly down to the lower end of the pathway 25 and then enters the solder bath via the bottom of the spiral or flows out though ports 39 into cup 57 and then into the bath 5 via the slots 59. The soldering operation can commence, as well known in the art. Whenever the solder flow is slowed so that there is a break in the flow of solder over the nozzle outlet 33, the pathway 25 can empty of solder and nitrogen gas will then flow into the pathway through the upper end of the cover and/or the ports 39.

Referring to FIG. 3, this shows a horizontal cross-section through the pump 9, with the outlet 71 to conduit 17 formed on a diameter of the pump chamber 73 housing the radial blade impeller 75. Thus, the conduit 17 extends away from the chamber wall 77 along a direction radial of the pump chamber 73. We believe that this might give particularly good control over the flow of solder and help reduce formation of solder dust.

1. A selective soldering apparatus comprising a bath for molten solder, a solder nozzle and a pump for pumping molten solder through the nozzle, the nozzle comprising a nozzle body with an inner bore through which solder is pumped to overflow a nozzle outlet, a jacket provided around the nozzle body to form an enclosed space open at its upper end to solder which has overflowed from the nozzle outlet and the cover lower end being adjacent the surface of molten solder in the bath, wherein a spiral pathway is provided in the enclosed space so that the overflowed solder runs down the pathway into the solder bath.

2. Apparatus as claimed in claim 1, wherein the lower end of the spiral extends to or into the surface of the solder in the bath to provide a continuous pathway into the solder in the bath.

3. Apparatus as claimed in claim 2, wherein a shroud is provided around the upper end of the nozzle and the cover, adjacent the nozzle outlet, and first inert gas feed means is provided for feeding nitrogen or other inert gas to the region of the nozzle outlet via the shroud.

4. Apparatus as claimed in claim 3, wherein second inert gas feed means is provided for directing preheated nitrogen or other inert gas to a point above the nozzle outlet.

5. Apparatus as claimed in claim 4, wherein the first and second inert gas feed means each comprises a thermally conductive tube which is in thermal contact with the solder bath.

6. Apparatus as claimed in claim 5, wherein the thermally conductive tubes are mounted on the outer surface of a wall of the solder bath.

7. Apparatus as claimed in claim 1, wherein a port is provided at the lower end of the jacket for inert gas to flow into or out of the spiral pathway.

8. Apparatus as claimed in claim 7, wherein a cup is provided around the jacket at the port to collect the solder exiting the jacket via the port.

9. Apparatus as claimed in claim 8, wherein the cup has apertures at its lower end to feed the solder back to the solder bath.

10. Apparatus as claimed in claim 1, wherein an overhang is provided on the outside of the nozzle body below the tip and above the spiral pathway.

11. A method of operating the apparatus of claim 7, wherein when starting the apparatus, with the solder at the required soldering temperature, an inert gas flow purges the space between the nozzle body and the jacket, and solder is then pumped through the nozzle body to overflow the nozzle outlet and run down into the spiral path way.

12. A selective soldering apparatus comprising a solder pump having a radial blade impeller in a substantially circular cross-section impeller pump chamber, wherein an outlet is formed on a diameter of the pump chamber.
